(19) United States
(12) Patent Application Publication
(10) Pub. No.: US 2006/0013728 A1
(43) Pub. Date: Jan. 19, 2006

(54) Material stability test kit

(76) Inventor: Peter Donald Moir, Dungarvan (GB)

Correspondence Address: BIRCH STEWART KOLASCH & BIRCH, PO BOX 747, FALLS CHURCH, VA, 22040-0747, US

(21) Appl. No.: 11/228,387

(22) Filed: Sep. 19, 2005

Related U.S. Application Data
(63) Continuation of application No. 10/111,813, filed on Jul. 1, 2002, now abandoned.

(30) Foreign Application Priority Data
Oct. 27, 1999 (IE) S99 0898

(51) Int. Cl. B01L 3/00

(52) U.S. Cl. 422/61

(57) ABSTRACT

A material stability test kit (50) has a container (51) which can be closed and sealed by a screw-on cover (52) after insertion of a test sample (26) together with a chemical humidifier (53) for generating a desired humidity within the container (51). The container (51) is of two part construction comprising an outer container (54) within which is nested a smaller inner container (55) supporting the test sample (26). The containers (54, 55) are of transparent material to allow viewing and inspection of the test sample (26) without removing the test sample from the container (51) which would disturb the desired climate condition generated within the container (51) by the humidifier (53). The humidifier (53) comprises a perforated receptacle (80) containing a saturated or non-saturated salt solution.

### BACKGROUND OF THE INVENTION

1. Field of the Invention

The invention relates to a material stability test kit, and in particular a kit for testing the stability of products and materials such as chemicals, pharmaceuticals, cosmetics, agrochemicals, biocides, construction (building) materials, microelectronic components, foods or food additives at different conditions of humidity and temperature.

2. Discussion of the Prior Art

During product development an integral part of the physio-chemical characterisation of substances, such as pharmaceuticals, food, food additive or other material development is the collection of large amounts of data on the stability of the material being developed at, for example, different temperatures and/or levels of humidity. This is essential because, for example, many drugs are unstable at high humidity, thus affecting the ability of the drug to be stored for any length of time. This is important not only in tropical countries, but also in temperate climates where relative humidity (RH) can vary between 10% to over 60% in very short periods. Changes in the physical characteristics of products range from those that are observed immediately, such as bad flowability or stickiness, to those that are more subtle and go unnoticed until long term stability failure, such as, poor dissolution of tablets or capsules. The effects of humidity and temperature are many and varied. Product degradation is an example of time dependent effects of temperature and humidity. An early warning of potential problems can have a substantial impact on product/process development and/or production costs and the time taken to put the product on the market.

Conventional test systems typically use relatively large humidity cabinets into which the material to be tested is placed. Such humidity cabinets typically use expensive air conditioning systems to maintain the desired level of humidity. Furthermore, the set humidity within the cabinet is disturbed upon opening of the cabinet in order to study the materials being tested or when inserting or removing samples. In addition, each sample is exhausted during testing and is not available for further testing.

The size of such cabinets also makes it difficult to study the effect of humidity at a variety of different temperatures, unless a large amount of laboratory space is set aside to accommodate such cabinets.

The present invention is directed towards overcoming these problems.

It is an object of the invention to provide an inexpensive system for testing the effects of humidity and temperature combinations on a material and which is easy and quick to set up.

### SUMMARY OF THE INVENTION

Accordingly, in one aspect of the invention a kit is provided for testing the stability of a material comprising a sealable container and a climate control means for establishing a desirable test microclimate within the sealed container. Preferably, the material stability test kit includes a container, the container having an inlet opening for loading a test sample within the container, means for closing and sealing said inlet opening, and climate control means for generating a desired climate condition within the container when the container is sealed.

In a preferred embodiment of the invention the climate control means is an individual climate control means. Preferably the climate control means is a chemical climate control means. In a particularly preferred embodiment, the climate control means is operable for generating a desired level of relative humidity within the container.

A desiccant, such as silica gel or zeolite compounds, may be used to create a relative humidity within the sealed container of less than 5%. Saturated salt solutions can be used to create desirable specific humidity environments. In one embodiment, low relative humidity is created by including in the sealed container a saturated solution of lithium chloride (LiCl). For example a relative humidity in the order of 11% can be created. In another embodiment medium humidity is created within the sealed container by including a saturated solution of magnesium nitrate (MgNO₃)₂. For example a relative humidity in the order of 62% can be created. In another embodiment high levels of humidity may be created within the sealed container by including a saturated solution of sodium hydroxide (NaOH). For example a relative humidity in the order of 80% can be created. Many different salts exist that when saturated can provide % relative humidities over the range of 5-95% approximately.

In another embodiment, a non-saturated salt solution is used for climate control. Preferably, the non-saturated salt solution is contained in a separate perforated vessel, receptacle or humidifying container. Surprisingly, such conditions have shown to equally create specifically determined humidity environments, with the perforations in the vessel allowing the passage of water vapour. More surprisingly, many different salts exist that when non-saturated can provide % relative humidities over the range of 5-95% approximately. The advantages of using a non-saturated salt solution are many: No water flowing around in the container, less chance of cross-contamination, no spillage problems, the humidifying container can be supplied, without the requirement of additional water to be added, the system is self contained and the humidifying container can be readily sealed with a pealable foil lid for shipping.

Preferably the chemicals for maintaining the humidity are selected to maintain the relative humidity at, for example, less than 5%, 10%, 25%, 60%, 75%, 90% or up to 100%. The chemical regulation of the humidity within the container is easy and quick to set up and produces repeatable levels of relative humidity.

In another embodiment the climate control means is a humidifier.

In one embodiment the container is made of a material such as glass or a plastic such as polypropylene or polyethylene terephthalate (PET). PET containers offer a durable container with excellent gloss, and the clarity and sparkle of glass. PET plastic bottles and jars are resistant to breakage, have excellent properties of carbonation retention, have high oxygen barrier, are light to handle and transport, and can be recycled. In a preferred embodiment the material from which the container is made is clear or transparent By having a portion of the container or the whole container transparent, the contents of the container can be easily observed and studied. The material to be tested can be viewed for change in appearance, for example discolouration, without the need to open the sealed container, thus maintaining the constant relative humidity.

In another embodiment a support to separately contain the material to be tested is provided within the container. The support or sample holder to contain the material to be tested maintains the material separate from the chemical for maintaining the humidity, thus preventing contamination of the material. In another embodiment the support may be held above the chemical for maintaining the humidity within the container by one or more walls of the container. In another embodiment, the support may be integral with a lid for the container. In a preferred embodiment the support means is compartmentalised, such that multiple samples may be tested within a single sealed container. In another embodiment the container may be compartmentalised. One compartment would contain the climate control means, whilst another would contain the material to be tested. The advantage of separating the individual chemicals is that contamination does not occur. Additionally, the material to be tested is retrievable for further testing if required. In another embodiment, the support may simply be in the form of a blister pack or other packaging system of the sort in which drugs in tablet or capsule form are typically sold. This would allow tablets or capsules to be tested in the packaged form in which they are to be sold.

The advantage of having the sample to be tested contained in a support separate from the humidity producing chemicals is that should further analysis of the sample be required, the sample can be retrieved from the support.

In another embodiment, the relative humidity within the container is calculated by the presence of a humidity indicator strip attached to the inside of the container. The advantage of this is that different % relative humidity is indicated by a different colour shade. Therefore, the specific relative humidity within the container is identifiable at a glance without having to open the container.

Preferably, the container may be in the form of a bottle or be substantially box-shaped to allow two or more containers to be stacked.

The material to be tested may be a drug active substance or formulation of it, cosmetic, agrochemical, construction (building) material, excipient, binder, microelectronic component food additive, foodstuff, or other material. The material may be in any suitable form such as for example powder form, tablet form or encapsulated. The encapsulated form would especially apply to drugs, the capsule being for example of a type used for oral administration.

The container may be maintained at a set temperature, for example, by the use of a controlled temperature incubator, refrigerator, water bath or oven. Types of apparatus for maintaining the temperature of the container are readily available within most laboratories hence a material may easily be tested at a wide variety of temperatures. Furthermore, the wide variety of chemical compounds, which may be used to maintain the humidity, means that the stability of a material may be tested over a wide range of humidities. Each test may be repeated at a variety of temperatures.

In another embodiment an apparatus is provided for testing the stability of a test sample at a set level of relative humidity comprising a container, having an opening for introduction of a test sample into the container, a cover for sealing engagement with the opening to provide an airtight seal between the cover and the opening, and climate control means for establishing a desirable test microclimate within the sealed container.

In a preferred embodiment means for supporting the test sample are provided within the sealed container. Conveniently, the container may have means for supporting a test sample remotely from the climate control means within the container.

In another embodiment means for keeping the test sample and the climate control means separate by compartmentalising are provided. The container may be divided into separate compartments which are in communication with each other. One or more dividing walls may be provided within the container for dividing the container into said separate compartments. In an alternative arrangement, the container is a two-part container which includes an outer container part and an inner container part with means for mounting the inner container part within the outer container part with an interior of each container part being in communication. Preferably, the inner container part is nestable within the outer container part, an upper end of the inner container part having an opening with a flanged rim extending around and defining said opening, the outer container part having a side wall with a plurality of inwardly extending projections on said side wall to engage and support the inner container part with said flanged rim seating on said projections. Conveniently, said projections are a plurality of spaced-apart elongate ribs which engage and support a side wall of the inner container.

Means may be provided for supporting a test sample above the climate control means within the container. Said support means may be mounted on or engagable with the container. Alternatively, said support means may be mounted on or engagable with a cover for the inlet opening of the container.

Another embodiment provides a method for testing the stability of a material at a set level of relative humidity comprising the steps of placing material to be tested in a container, with climate control means for establishing a desirable test microclimate and sealing the container.

A further aspect of the invention provides a method for testing the stability of a material and distinguishing between temperature and humidity effects independent of each other by establishing low humidity as described and high humidity over any desired range within the specified limitations of the system.

In another embodiment the container may be sealed by means of a screw cap, a rubber cap crimped into position over an aperture or by other suitable sealing means for maintaining the humidity within the container. In another embodiment, a tamper resistant seal can be additionally added to the container. The advantage of this is that it would be clearly evident, as to whether the sample had been interfered with.

Another embodiment of the invention provides a kit for testing the stability of one or more materials comprising at least one sealable container and climate control means.

### BRIEF DESCRIPTION OF THE DRAWINGS

The invention will be more dearly understood by the following description of some embodiments thereof, given by way of example only, with reference to the accompanying drawings, in which:

FIG. 1 shows a schematic cross section through a test kit according to the invention;

FIG. 2 is a schematic illustration similar to FIG. 1 showing a second embodiment of the invention;

FIGS. 3A and 3B are also schematic illustrations similar to FIG. 1 showing third and fourth embodiments of the invention;

FIG. 4 is a sectional elevational view of a test kit according to a fifth embodiment of the invention;

FIG. 5 is an enlarged sectional elevational view of an outer container forming portion of the test kit of FIG. 4;

FIG. 6 is an enlarged sectional elevational view of an inner container forming portion of the test kit of FIG. 4;

FIG. 7 is an enlarged sectional elevational view of a sealed pot containing a humidifier forming portion of the test kit of FIG. 4;

FIG. 8 is an enlarged sectional elevational view of a cover for the outer container shown in FIG. 5; and

FIG. 9 and FIG. 10 are graphs illustrating operation of the test kits of the invention.

### DESCRIPTION OF PREFERRED EMBODIMENTS

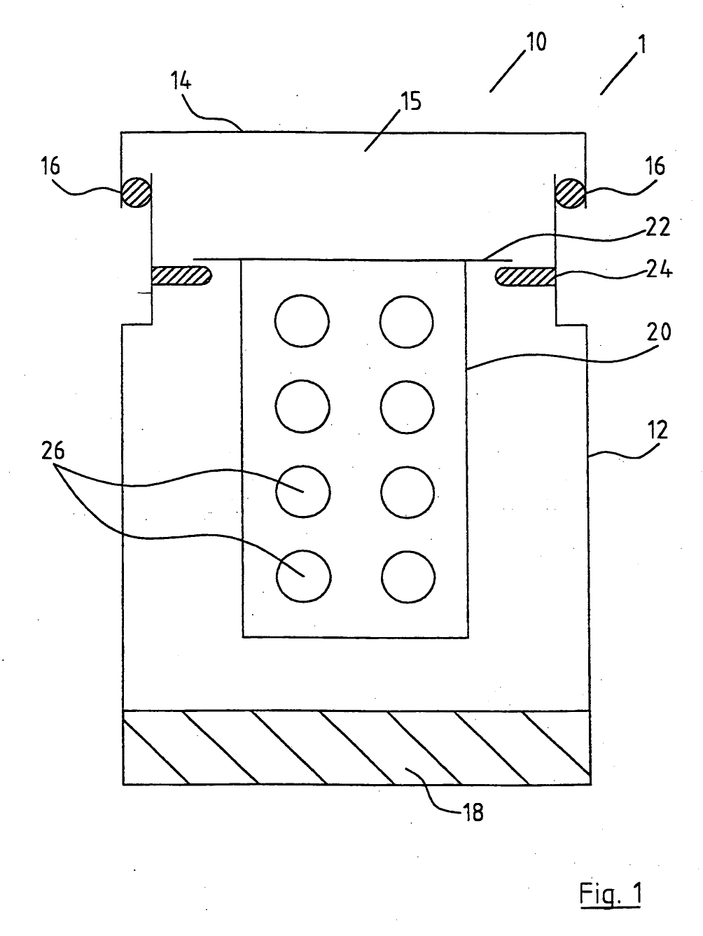

FIG. 1 shows a kit, indicated generally by the reference numeral 1, for testing the stability of a material 10 comprising a bottle 12 and lid 14 for closing an inlet opening 15 at a neck of the bottle 12. The bottle 12 and for lid 14 are typically made out of a transparent or partially transparent material such as glass or a plastic such as polypropylene or PET. This allows the contents of the bottle 12 to be seen without opening the bottle 12. The bottle 12 may have a substantially cylindrical body, but may also be box-shaped, that is with a substantially rectangular body. The latter form enables the bottle 12 to be stacked more easily for ease of storage and use.

The lid 14 may be a screw-type lid, in which case it may be sealed by screw threads, shown in cross-section as 16. Alternatively, the lid 14 may be a press-on type lid and use a rubber bring as a seal. In another alternative embodiment, a crimped rubber cap may also be used to seal the bottle 12. Any suitable method of sealing the bottle 12 or other container may be used.

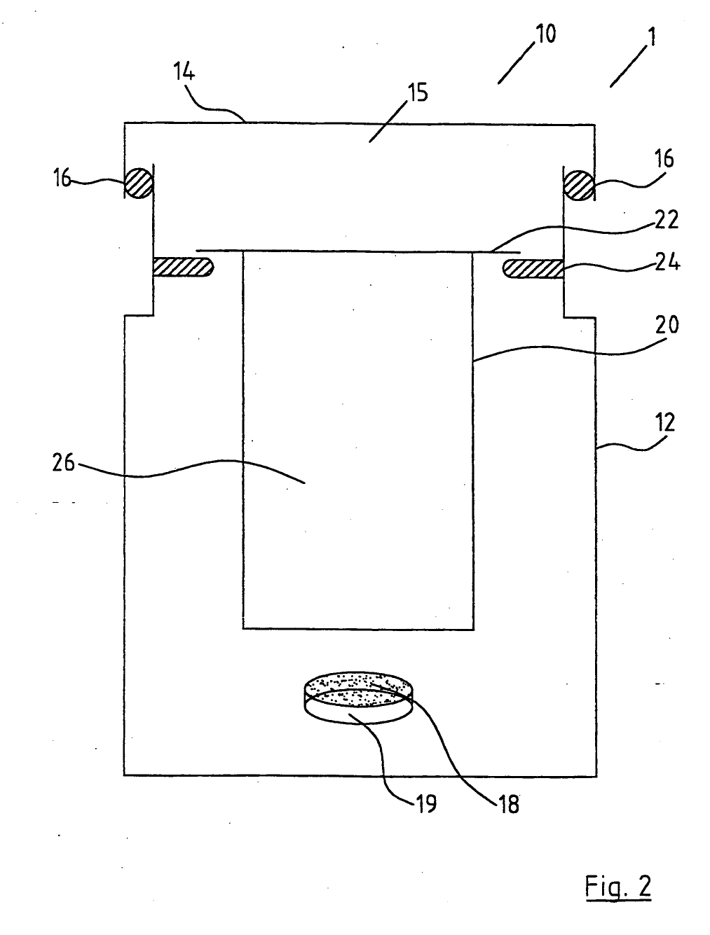

In the bottle 12 is placed climate control means comprising one or more chemicals 18 to maintain a pre-set humidity within the bottle 12. Examples include silica gel, and saturated solutions of lithium chloride (LiCl), magnesium nitrate (MgNO₃)₂ or sodium hydroxide (NaOH). Each of these compounds is capable of maintaining the humidity at a preset level. FIG. 2 demonstrates an alternative embodiment whereby desiccant or non-saturated salt solutions are contained in a separate receptacle or vessel 19, which is preferably perforated to allow the passage of water vapour. This is generally more convenient

A support 20 is shown suspended within the bottle 12 by means of arms 22, which rest upon ledges 24 within the bottle 12. One or more supports 20 may be used within the bottle 12. The support 20 is used to hold a material 26 to be tested. One or more samples of material 26 to be tested may be placed upon each support 20. The material 26 may be placed within an aperture in the support 20 or adhered to or otherwise mount on the support 20. Alternatively, support 20 may be a blister-type package into which the material to be tested has been placed. In this case, a clip may be attached at one edge of the blister pack to form the arms 22 for suspending the blister pack within the bottle 12.

Support 20 is preferably made of a transparent material such as plastic or glass to allow a clear view of the material 26 to be tested. The support 20 for the material to be tested may also be in the form of a vial, cup or other vessel to hold the material 26 to be tested. In an alternative embodiment the support may simply rest with a foot portion of the support within the chemicals 18 rather than suspending it on the bottle 12 as described above.

In an alternative embodiment chemicals 18 may be placed within a separate vessel 19, such as a vial, in order to keep them separate from the materials 26 to be tested. Preferably, the separate vessel 19 is perforated to allow the passage of air. Where such a system is used the material to be tested may simply be placed in the bottom of the bottle 12, the base of the bottle 12 acting as a support That is, the support may be an integral part of the container or a separate part of the container. A separate support is advantageous because it allows the materials to be tested to be easily placed within the container and withdrawn from the container.

In use the sealed bottle 12 containing the materials to be tested 26 at the specified humidity is incubated at a specified temperature. Periodically the materials 26 being tested may be examined by looking through the transparent part of the bottle 12. A visual inspection is often all that is required to detect deterioration in the material 26 being tested. An advantage of the current invention is that such a visual inspection can take place without having to open the bottle 12, thus maintaining the humidity within the bottle 12.

If any more detailed inspection of the test material 26 tablets is required, the lid 14 may simply be removed from bottle 12, and the material 26 removed for further testing by, for example, chromatographic techniques such as HPLC.

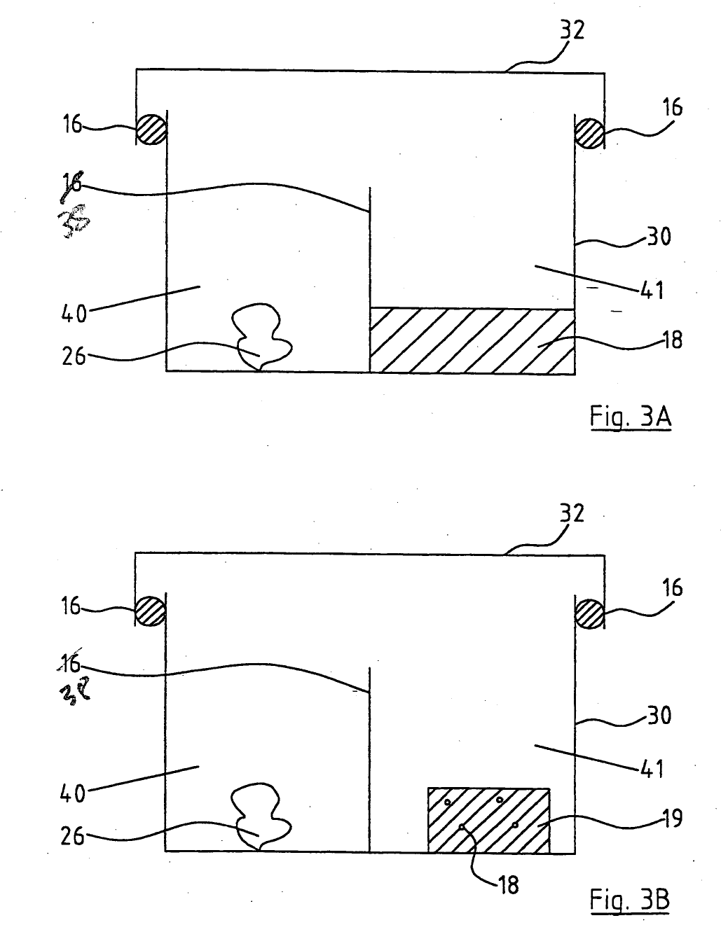

FIGS. 3A and 3B represent other embodiments of the invention for testing the stability of a test material 26 comprising a bottle 30 and lid 32. The bottle 30 is divided into individual compartments 40 and 41 by a dividing wall 38. This maintains the separation of the material to be tested 26 from a climate control means 18. FIG. 3B demonstrates an embodiment where the climate control means 18 are further contained in a plastic perforated container 19 within the compartment 41.

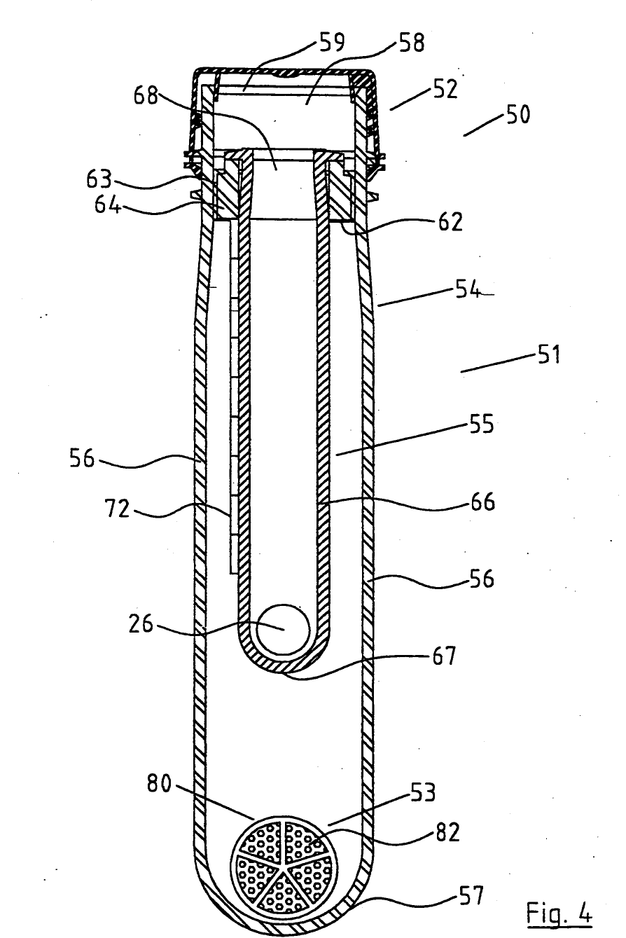

Referring now to FIGS. 4 to 8 there is shown a material stability test kit according to another embodiment of the invention indicated generally by the reference numeral 50. The test kit 50 has a container 51 closed by a screw-on cover 52, the container 51 being for reception of a test sample 26 together with a humidifier 53 for generating a desired humidity within the container 51.

The container 51 formed of PET and is of two-part construction comprising an outer container 54 within which is nested a smaller inner container 55 for supporting a test sample within the outer container 54. The outer container 54 has a generally cylindrical side wall 56 with a hemispherical bottom 57 and an open top 58. A circular rim of 59 at the top 58 of the side wall 56 defines an inlet opening for insertion and removal of the inner container 55. It will be noted that an inner lip 60 of the rim 59 is tapered. On an exterior of the top 58 a number of a multi-start threads 61 are provided for engagement with the cover 52.

Mounted within the top 58 of the outer container 54 is a hanging bracket 62 upon which the inner container 55 is suspended in use. The hanging bracket 62 has a cylindrical body 63 with a number of inwardly extending radial ribs 64 which both guide and support the inner container 55.

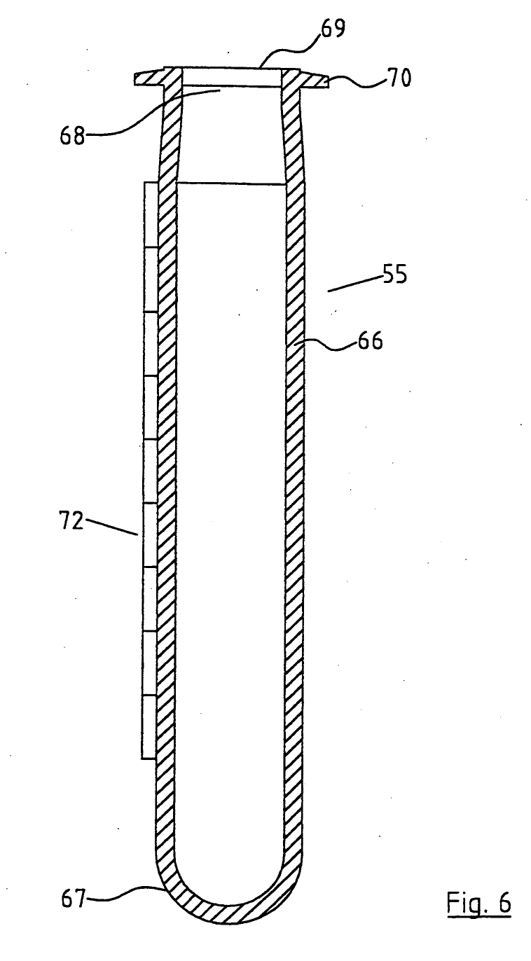

As can be seen in FIGS. 4 and 6 the inner container 55 also has a cylindrical side wall 66 with a hemispherical bottom 67 and an open top 68 having a rim at 69 with an outwardly extending annular flange 70. Upon insertion of the inner container 55 into the outer container 54 the annular flange 70 seats on a top face of the ribs 64. A humidity indicating strip 72 is mounted on an outside face of the inner container 55, coloration of the strip 72 during use giving an indication of the humidity within the outer container 54.

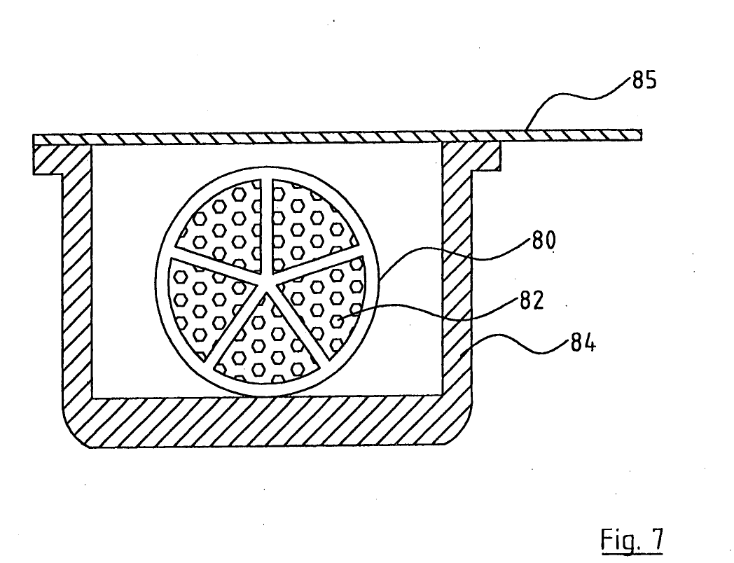

The humidifier 53 comprises a cylindrical vial or receptacle 80 having perforated ends 82 and containing a selected non-saturated salt solution for generating a desired humidity within the outer container 54. A receptacle 80 prior to use is housed within a pot 84 (FIG. 7) which is sealed by a peal-away strip 85.

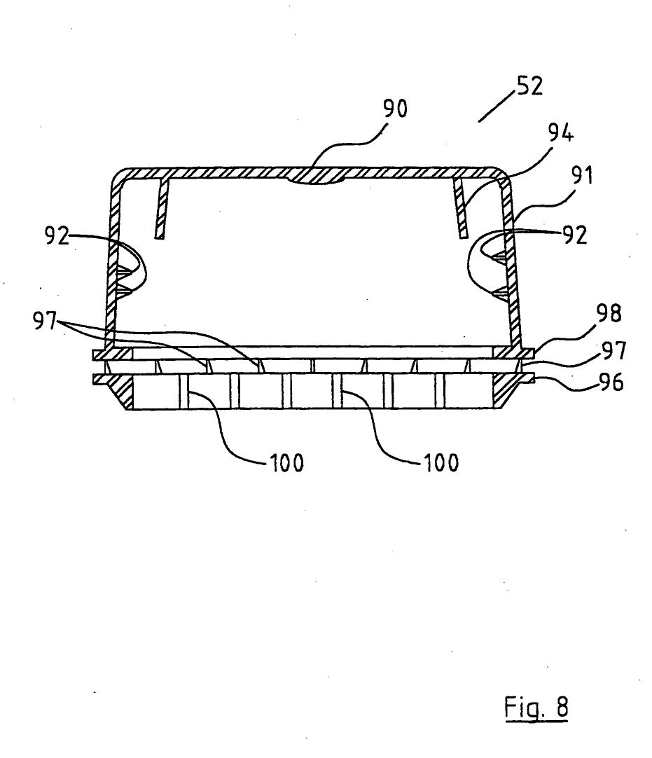

Referring in particular to FIG. 4 and FIG. 8 the cover 52 has a circular top wall 90 with a downwardly depending side wall or skirt 91. Multi-start threads 92 are provided on an inside face of the skirt 91 for complementary engagement with the threads 61 on the outer container 54 to releasably secure the cover 52 on the outer container 54. A sealing ring 94 extends downwardly from an inside face of the top wall 90 for sealing engagement with the top 58 of the outer container 54. The tapered lip 60 guides the ring 94 into sealing engagement with the top 58 of the outer container 54.

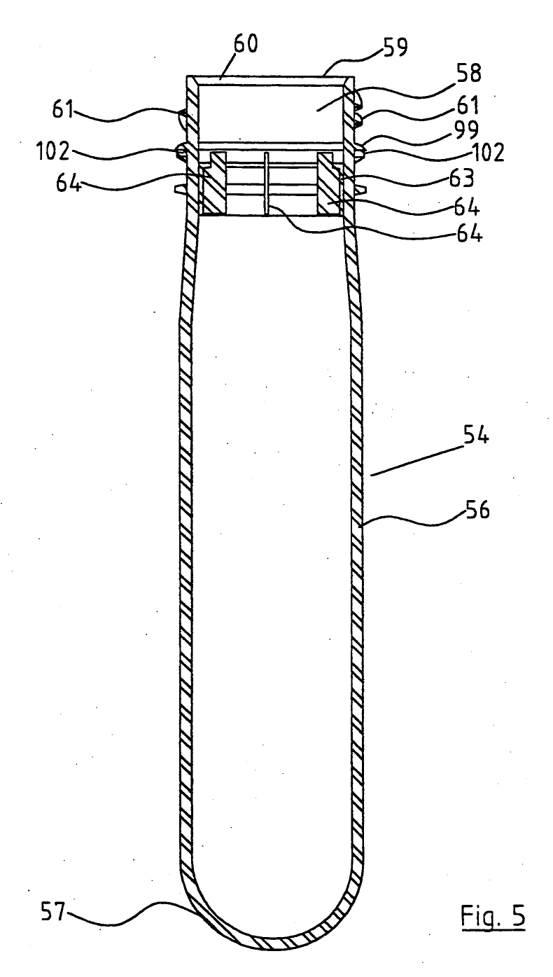

At a lower end of the skirt 91 a tamper indicating ring 96 is provided connected by break-away tabs 97 to a bottom flange 98 on the skirt 91. On an exterior of the outer container 54 at the top 58 of the outer container 54 a downwardly and outwardly curved ramp 99 (FIG. 5) is provided. As the cover 52 is of plastics material, the cover 52 is sufficiently resilient so that it can be eased over the ramp 99. Ribs 100 on an inside face of the ring 96 cooperate with associated radial projections 102 on an exterior of the outer container 54 such that when the cover 52 is rotated for removal from the outer container 54 the ribs 100 engage against the projections 102 to prevent rotation of the tamper indicating ring 96. Thus the tabs 97 break parting the ring 96 from the skirt 91 of the cover 52 to give indication of removal of the cover 52 from the outer container 54.

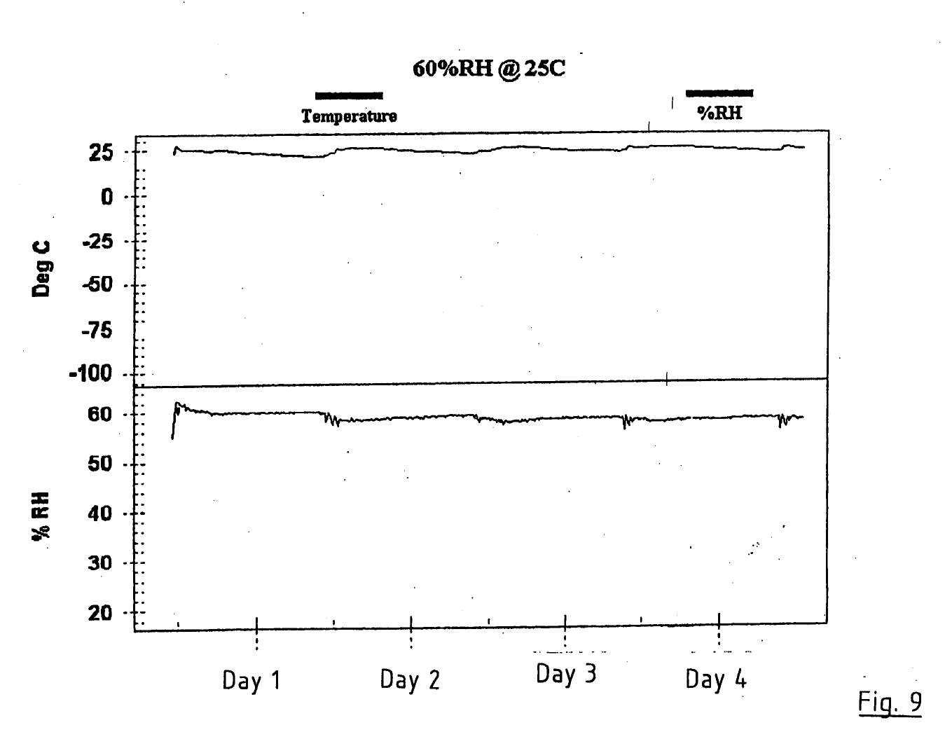

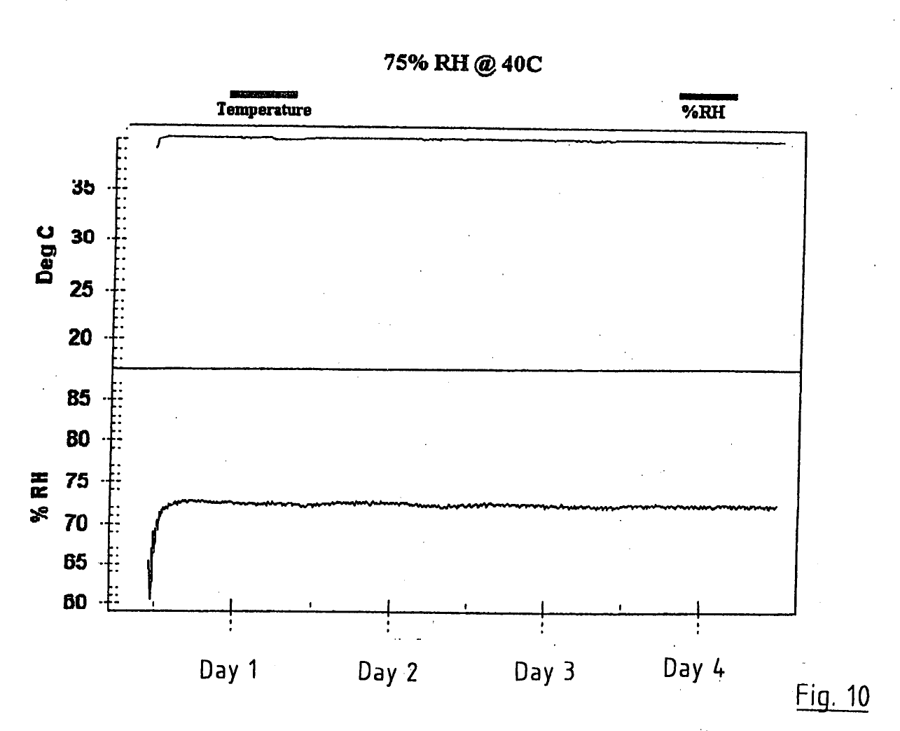

FIG. 9 and FIG. 10 show graphs illustrating different relative humidity and temperature conditions for stability testing using the kits of the invention. A range of different relative humidities can be provided by kits of the invention for stability testing of products and materials.

In use, the strip 85 is peeled away from the pot 84 and the receptacle 80 is dropped into the outer container 54. Next a sample test material 26 is loaded in the inner container 55 which is then inserted into the outer container 54 as shown in FIG. 4. Then the cover 52 is screwed into place on the outer container 54 to seal the outer container 54. The humidifier 53 generates the desired conditions of relative humidity within the outer container 54 to provide the desired stability testing of the product within the inner container 55. It will be noted that as both the outer container 54 and inner container 55 are of transparent plastics material the product can be viewed as desired without having to open the container 51.

One major advantage of the invention is that the effects of temperature and humidity may be more easily determined. The temperature effect may easily be determined independently of humidity by placing a desiccant within the sealed container and incubating the material within the sealed system at various temperatures. This is especially important since changes in temperature and humidity can lead to separate effects on the material, for example a drug being tested. The present invention enables their individual effects to be differentiated.

An excess of a water-soluble salt in contact with its saturated solution within the enclosed environment of the stability test microclimate container produces a constant relative humidity (RH) and water vapour pressure. Accordingly, the RH achieved varies with different salt compounds and the surrounding temperature. The RH achieved is effected through altering the vapour pressure of water to a value that can be calculated from:
p=(RH/1000)×pₒ Eq. 1

Where p is the new vapour pressure; RH the relative humidity and pₒ is the vapour pressure of pure water at a given temperature. RH can be calculated from constants provided in chemical texts such that:
RH=A exp(B/T) Eq. 2

Where A and B are constants and T is the temperature in degrees Kelvin.

Saturation humidity, that is, air completely saturated with moisture, is achieved when the partial pressure of water vapour is equal to the vapour pressure of free water at the same temperature. This is the situation at 100% RH where by substitution in Eq. 1:
p=pₒ

Since saturated solutions lower the vapour pressure value pₒ according to Eq. 2, then the maximum amount of water that can be present in the air enclosed within the stability system container will always be below the saturation humidity for a given temperature.

Saturation humidity is related to absolute humidity (that is, the weight of water per weight of dry air) through temperature, and can be found on most psychrometric charts. Information relating to RH to saturating humidity and absolute humidity is superimposed on the psychrometric chart, thus allowing absolute humidity to read from a given temperature.

It follows that the RH produced by a given saturated salt solution can be used to calculate the percentage (weight basis) of water present in the air space of the stability test microclimate container enclosure. Hence the total amount of water required to achieve the desired RH can be estimated from the volume of air space. It then follows that an amount of water can be calculated that must at least be present as part of the salt solution in order to allow by evaporation the desired RH adjustment from ambient humidity for a new equilibrium to be established. Equally, it follows that an amount of water can be calculated that must condense into a salt solution, or be absorbed onto desiccant, to achieve a new equilibrium for a RH adjustment from ambient humidity.

In the present invention, a novel effect has been observed with the addition of water to various salts at weight to weight ratios that are below saturation of the salt.

Accordingly, water and mixtures are provided, comprising in combination an inorganic salt and water. Preferably the inorganic salt and water mixture are in an enclosed container. Most preferably, the amount of salt present is in a particular ratio to the amount of water present.

In the above mixtures, the water is normally purified in some way (e.g. distillation) and has the principal function of providing water vapour to achieve a specified RH value±a range of no greater than 5% RH.

The salt is chosen according to the desired and specified RH. Examples of inorganic salts include: lead nitrate, dibasic sodium phosphate, monobasic ammonium phosphate, zinc sulphate, potassium chromate, potassium bisulfate, potassium bromide, ammonium sulfate, ammonium chloride, sodium acetate, sodium chlorate, sodium nitrate, sodium bromide, magnesium nitrate, sodium dichromate, potassium thiocyanate, zinc nitrate, chromium trioxide, calcium chloride, potassium acetate and lithium chloride.

In this specification, the terms “comprise”, “comprise” and “comprising” are used interchangeably with the terms “include”, “includes” and “including”, and are to be afforded the widest possible interpretation and vice versa.

The invention is not limited to the embodiments hereinbefore described but may be varied in construction and detail within the scope of the appended claims.

1-20. (canceled)

21. A materials stability test kit, including:
a container,
the container having an inlet opening for loading a test sample within the container,
means for closing and sealing said inlet opening, and
climate control means for generating a desired climate condition within the container when the container is sealed, wherein the climate control means is an unsaturated salt solution mounted within a receptacle having a perforated sidewall.

22. A test kit as claimed in claim 21 wherein the climate control means is operable for generating a desired level of relative humidity within the container.

23. A test kit as claimed in claim 21 wherein the container has means for supporting a test sample remotely from the climate control means within the container.

24. A test kit as claimed in claim 23 wherein the container is divided into separate compartments which are in communication with each other.

25. A test kit as claimed in claim 24 wherein one or more dividing walls are provided within the container for dividing the container into said separate compartments.

26. A test kit as claimed in claim 24 wherein the container is a two-part container which includes an outer container part and an inner container part with means for mounting the inner container part within the outer container part with an interior of each container part being in communication.

27. A test kit as claimed in claim 26 wherein the inner container part is nestable within the outer container part, an upper end of the inner container part having an opening with a flanged rim extending around and defining said opening, the outer container part having a side wall with a plurality of inwardly extending projections on said side wall to engage and support the inner container part with said flanged rim seating on said projections.

28. A test kit as claimed in claim 27 wherein said projections are a plurality of spaced-apart elongate ribs which engage and support a side wall of the inner container.

29. A test kit as claimed in claim 23 wherein means is provided for supporting a test sample above the climate control means within the container.

30. A test kit as claimed in claim 29 wherein said support means is mounted on or engageable with the container.

31. A test kit as claimed in claim 29 wherein said support means is mounted on or engageable with a cover for the inlet opening of the container.

32. A test kit as claimed in claim 29 wherein at least portion of a side wall of the container is transparent to allow viewing of a test sample within the container.

33. A test kit as claimed in claim 21 wherein a humidity indicator strip is provided for mounting within the container.

34. A test kit as claimed in claim 21 wherein a cover is provided which is engageable with the container to close the inlet opening, said cover being provided with a tamper indicating means.

35. A test kit as claimed in claim 21 wherein said receptacle is mounted within a pot closed by a tear-away cover strip to seal the receptacle within the pot prior to use.

36. A method for stability testing a material test sample, comprising the steps of inserting the test sample into a container together with a chemical climate control means comprising an unsaturated salt solution mounted within a receptacle having a perforated sidewall, and closing and sealing the container for generating a desired climate control condition within the container for a desired test period.
